(19) United States
(12) Patent Application Publication
(10) Pub. No.: US 2024/0223885 A1
(43) Pub. Date: Jul. 4, 2024

(54) AUTOFOCUS ADJUSTMENT METHOD AND CAMERA DEVICE USING SAME

(71) Applicant: HANWHA VISION CO., LTD., Seongnam-si (KR)

(72) Inventors: Dae Bong KIM, Seongnam-si (KR); Dong Jin Park, Seongnam-si (KR); Ki Bum Park, Seongnam-si (KR); Young Sang Kwon, Seongnam-si (KR)

(73) Assignee: Hanwha vision CO., LTD.., Seongnam-si (KR)

(21) Appl. No.: 18/601,362

(22) Filed: Mar. 11, 2024

Related U.S. Application Data
(63) Continuation of application No. PCT/KR2022/007016, filed on May 17, 2022.

(30) Foreign Application Priority Data
Apr. 29, 2022 (KR) 10-2022-0053253

(51) Int. Cl. H04N 23/611; G06T 7/50; G06T 7/60; G06V 10/776; H04N 23/67

(52) U.S. Cl. CPC H04N 23/611; G06T 7/50; G06T 7/60; G06V 10/776; H04N 23/67; G06T 2207/30201

(57) ABSTRACT

A camera device includes an image sensor configured to capture an image, an object identifier configured to identify an object included in the captured image, a distance measurement device configured to determine a distance between the camera device and the identified object based on an occupancy percentage of the identified object in the captured image, and a controller configured to determine an optimal focus location where a reference value is the largest while moving a lens in a focus range corresponding to the determined distance between the camera device and the identified object, the focus range including at least a focus location of the lens.

### CROSS-REFERENCE TO RELATED APPLICATIONS

This application is a continuation of International Application No. PCT/KR2022/007016, filed on May 17, 2022, in the Korean Intellectual Property Receiving Office, which is based on and claims priority to Korean Patent Application No. 10-2022-0053253, filed on Apr. 29, 2022, in the Korean Intellectual Property Office, the disclosures of which are incorporated herein by reference in their entireties.

### BACKGROUND

### 1. Field

The disclosure relates to autofocus adjustment technology, and more particularly, to an autofocus adjustment method and device capable of performing rapid autofocus adjustment by estimating a distance between a lens and a subject.

### 2. Description of Related Art

Electronic devices, such as digital cameras and digital video cameras, are mounted with image capturing devices, such as charge coupled device (CCD) or complementary metal oxide semiconductor (CMOS) image sensors. The image capturing device has an autofocus (AF) function that automatically adjusts a focus. In AF, the focus is adjusted by driving a lens, and it is possible to acquire such a focused image.

However, in AF according to the related art, the focus cannot be automatically adjusted to a part desired by a user depending on a subject (i.e., a target). In this case, the user has to perform a manipulation for focus adjustment when an image is captured, and thus, the user may not capture an image when performing the image capturing.

Furthermore, it may be necessary to adjust a distance between the lens and an image sensor by changing a location of the lens and perform focusing of an image of the subject in order to use such an AF function, and thus, a time delay for finding an optimal focus location occurs.

As illustrated in FIG. 1, a camera according to the related art may include a lens 1, an image sensor 2 capturing an image of a subject transmitted through the lens 1, an image processor 3 processing information on the image captured by the image sensor 2 to generate sharpness indicating a degree of focusing of the image, a controller 5 determining an appropriate location of the lens 1 according to the sharpness of the image processor 3, and a lens driver 4 for moving the lens 1 to the location determined by the controller 5.

Specifically, when an AF command is input by a user's camera manipulation or the like, the controller 5 initializes a location of the lens 1 by moving the lens 1 to an initial location, which is either the farthest distance location, which is a location closest to the image sensor (a location farthest from the subject) or the nearest distance location, which is a location farthest from the image sensor (a location closest to the subject). Thereafter, the controller 5 determines the sharpness (e.g., contrast data) at respective locations of the lens 1 while moving the lens 1 at regular intervals, and determines a location of the lens 1 having the maximum sharpness of the sharpness values.

Thereafter, the controller 5 moves the lens 1 again to the vicinity of a point having the maximum sharpness, determines the sharpness at respective locations of the lens 1 while short moving the lens 1 in a predetermined range of the vicinity of the point having the maximum sharpness, and finally determines a point having the maximum sharpness of the sharpness values.

Finally, the controller 5 moves the lens 1 to the point having the maximum sharpness and then completes autofocusing.

As described above, the AF function according to the related art should determine sharpness for all regions where the location of the lens is changed, and thus, a time required for autofocusing increases, and when rapid autofocusing is performed in order to decrease the time required for autofocusing, accuracy of the autofocusing decreases.

### SUMMARY

Provided is an autofocus (AF) adjustment method and camera capable of improving contrast-based AF performance through artificial intelligence (AI) deep learning-based object detection technology.

Provided is an AF adjustment method and camera capable of improving an AF speed by estimating a distance between a subject and a lens using detected object information and lens/sensor information.

Provided is an AF adjustment method and camera capable of improving AF performance using object detection information during an autofocusing operation.

Additional aspects will be set forth in part in the description which follows and, in part, will be apparent from the description, or may be learned by practice of the presented embodiments.

According to an aspect of the disclosure, a camera device may include an image sensor configured to capture an image, an object identifier configured to identify an object included in the captured image, a distance measurement device configured to determine a distance between the camera device and the identified object based on an occupancy percentage of the identified object in the captured image, and a controller configured to determine an optimal focus location where a reference value is the largest while moving a lens in a focus range corresponding to the determined distance between the camera device and the identified object, the focus range including at least a focus location of the lens.

The reference value may include contrast data or edge data.

The camera device may include a storage configured to store specification information of the camera device, where the distance measurement device may be further configured to obtain an angle of view in a vertical direction from the specification information, the distance measurement device may be configured to determine the distance between the camera device and the identified object based on the obtained angle of view in the vertical direction, a ratio of a size of the identified object, and a physical size of the identified object, and the ratio of the size of the identified object may correspond a ratio of a size of at least a portion of the identified object in the vertical direction to a size of the captured image in the vertical direction.

The object may include a person and the portion of the object may include a face of the person.

The object may include a vehicle, and the portion of the object may include a license plate of the vehicle.

The controller may be further configured to obtain locus data from the specification information stored in the storage and determine the focus range based on the determined distance between the camera device and the identified object and based on the locus data, and the locus data may correspond to a focus location determined based on a distance to the object at a specific zoom magnification.

The captured image may include a plurality of objects, and the identified object may be an object selected among the plurality of objects.

The identified object may be selected as an object closest to a center of the captured image among the plurality of objects.

The identified object may be selected as an object including a size that is standardized among the plurality of objects.

The object identifier may be configured to identify the object based on a deep learning-based object detection algorithm, the object identifier may be configured to obtain an accuracy of the plurality of objects based on the deep learning-based object detection algorithm, and the identified object may be selected as an object having higher accuracy among the plurality of objects.

The controller may be further configured to set a window in the captured image around the identified object, and the controller may be configured to determine the optimal focus location in the set window.

The object identifier may be configured to identify the object based on a deep learning-based object detection algorithm, the object identifier may be configured to obtain an accuracy of the identified object based on the deep learning-based object detection algorithm, and the focus range may be set based on the obtained accuracy.

The controller may be further configured to set a window in the captured image based on a movement of the identified object, and the controller may be configured to determine the optimal focus location in the set window.

The controller may be further configured to change a size of the window based on the movement of the identified object with respect to the image sensor.

The controller may be further configured to moves and set the window to a predicted location based on movement of the identified object to another location in the captured image.

According to an aspect of the disclosure, an AF adjustment method performed by a camera device may include capturing an image, identifying an object included in the captured image, determining a distance between the camera device and the identified object based on an occupancy percentage of the identified object in the captured image, moving a lens in a focus range of the lens based on the determined distance between the camera device and the identified object, the focus range including at least a focus location of the lens, and determining an optimal focus location where a reference value is the largest while moving the lens.

The method may include obtaining an angle of view in a vertical direction based on specification information of the camera device, where determining the distance between the camera device and the identified object may be performed based on the obtained angle of view in the vertical direction, a ratio of a size of the object, and a physical size of the object, and the ratio of the size of the identified object may correspond to a ratio of a size of at least a portion of the identified object in the vertical direction to a size of the captured image in the vertical direction.

The captured image may include a plurality of objects, the identified object may be an object selected among the plurality of objects, and the identified object may be selected as an object closest to a center of the captured image among the plurality of objects.

The captured image may include a plurality of objects, the identified object may be an object selected among the plurality of objects, and the identified object may be selected an object including a size that is standardized among the plurality of objects.

The identifying of the object may be performed based on a deep learning-based object detection algorithm, and the identifying the object may include obtaining an accuracy of the identification of the object, and identifying the object as an object having higher accuracy among a plurality of objects included in the captured image.

According to an aspect of the disclosure, a non-transitory computer-readable storage medium may store instructions that, when executed by at least one processor, cause the at least one processor to capture an image, identify an object included in the captured image, determine a distance between a camera device and the identified object based on an occupancy percentage of the identified object in the captured image, move a lens in a focus range of the lens based on the determined distance between the camera device and the identified object, the focus range including at least a focus location of the lens, and determine an optimal focus location where a reference value is the largest while moving the lens.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram illustrating a camera having an autofocus (AF) function according to the related art;

FIG. 2 is a block diagram illustrating a configuration of a camera device according to some embodiments of the present disclosure;

FIGS. 3A to 3C are diagrams illustrating examples of determining distances to specific objects using only images captured by the camera device according to some embodiments of the present disclosure;

FIG. 4 is a diagram illustrating a process of determining an optimal focus location where a reference value is the largest according to some embodiments of the present disclosure;

FIG. 5 is a graph of locus data illustrating a change in focus location at a specific magnification according to some embodiments of the present disclosure;

FIG. 6 is a diagram illustrating an example of determining a distance based on an object close to the center of an image among a plurality of objects according to some embodiments of the present disclosure;

FIGS. 7A and 7B are diagrams illustrating a method of setting an AF window used when a controller determines a location of a lens having maximum sharpness from contrast data according to some embodiments of the present disclosure;

FIG. 8A is a block diagram illustrating an artificial intelligence (AI) device according to some embodiments of the present disclosure;

FIG. 8B is a diagram illustrating an example of a deep neural network (DNN) model according to some embodiments of the present disclosure;

FIG. 9 is a block diagram illustrating the hardware configuration of a computing device that implements a camera device according to some embodiments of the present disclosure; and

FIG. 10 is a flowchart illustrating an AF adjustment method in a camera device according to some embodiments of the present disclosure.

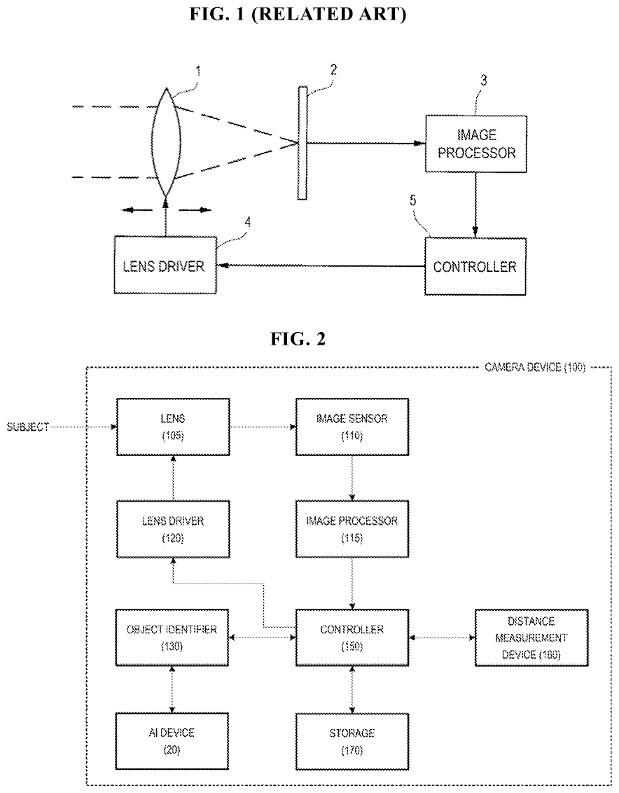

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c

Hereinafter, example embodiments of the present disclosure will be described in detail with reference to the accompanying drawings.

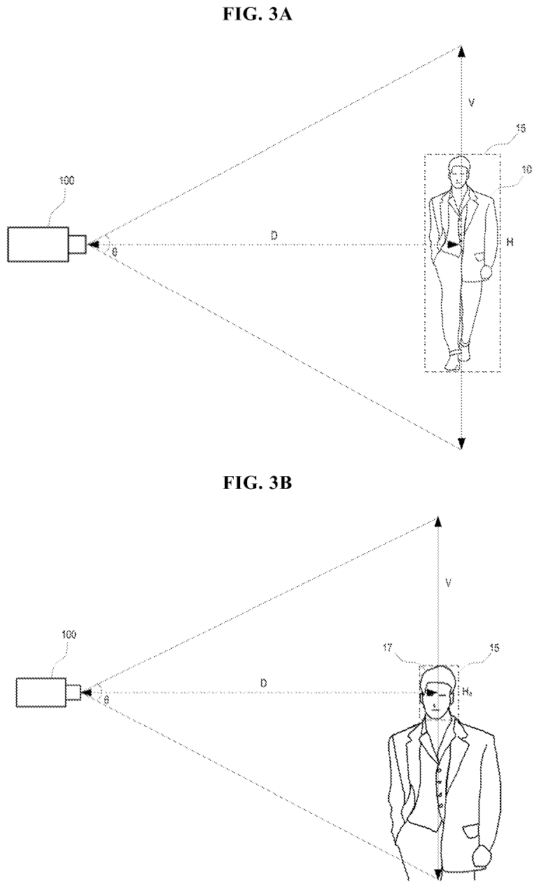

FIG. 2 is a block diagram illustrating a configuration of a camera device 100 according to some embodiments of the present disclosure. The camera device 100 may include a lens 105, an image sensor 110, an image processor 115, a lens driver 120, an object identifier 130, an artificial intelligence (AI) device 20, a controller 150, a distance measurement device 160, and a storage 170.

The controller 150 may control operations of other components of the camera device 100, and may generally be implemented as a central processing unit (CPU), a microprocessor, or the like. In addition, the storage 170 may be a storage medium storing a result generated by the controller 150 or data necessary for an operation of the controller 150, and may be implemented as a volatile memory or a non-volatile memory.

The lens 105 may be opened or closed by a shutter, and may introduce light reflected from a subject in a state where the shutter is opened. The lens driver may move the lens 105 (forward or backward) in a predetermined range for focus adjustment. The lens driver 120 may generally be implemented as a rotary motor, a linear motor, or various other types of actuators.

The image sensor 110 may capture an image in a manner of capturing light input to the lens 105 in the state where the shutter is opened and may output the captured light as an electrical signal. Such an image may be displayed as an analog signal or a digital signal. The digital signal may be pre-processed by the image processor or an image signal processor (ISP) and then provided to the controller 150. The digital signal may be is temporarily or permanently stored in the storage 170.

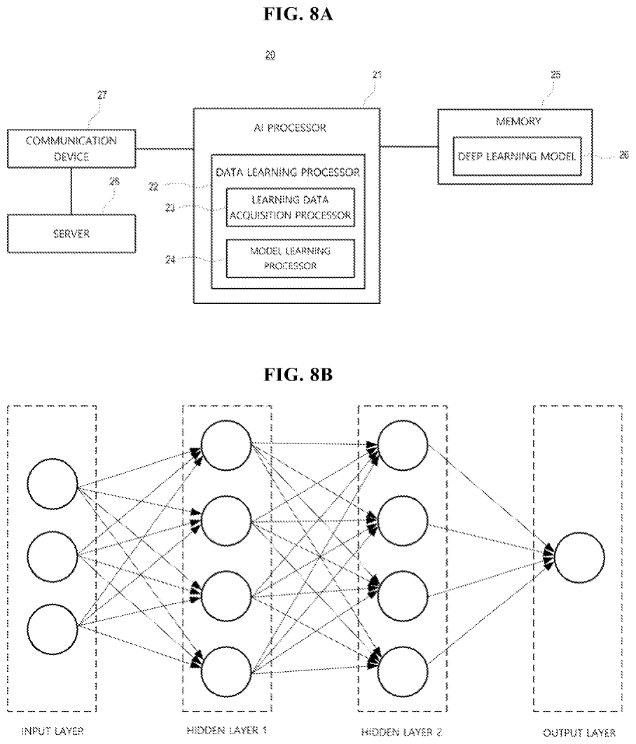

The object identifier 130 may identify an object included in the captured image. The object identifier 130 may be a software component or module implemented by the controller 150, an AI software component, hardware component, or an equivalent device or structure. The object may refer to a target that may be distinguished from a background and that has independent movement, such as a person or other object type included in an image. The identification of the object may be performed through a deep learning algorithm by the AI device 20. The AI device 20 will be described in more detail later with reference to FIGS. 8A and 8B. The object identified by the object identifier 130 may generally be defined by an object ID, a type of object, an object probability, an object size, and the like. The object ID may be an arbitrary identifier indicating whether or not the object is identical, and the type of object may indicate a class that may be distinguished by a person, such as a person, an animal, and a vehicle. In addition, the object probability may be a numerical value indicating an accuracy with which the object would have been correctly identified. For example, when a type of specific object is a person and the object probability is 80%, the object probability may indicate that the probability that the object will be the person is 80%.

The distance measurement device 160 may determine (e.g., measure, calculate, etc.) a distance between the camera device 100 and the identified object based on an occupancy percentage of the identified object in the captured image. The distance measurement device 160 may include a LiDAR (light direction and ranging), a laser range finder, or an equivalent device or structure. The distance measurement device 160 may also directly measure a distance to the identified object. That is, the distance measurement device may include a laser-based distance measuring device. Hereinafter, example embodiments will be described based on the distance is determined by analysis of the image such as the occupancy percentage of the object in the image, but embodiments disclosed herein are not limited thereto.

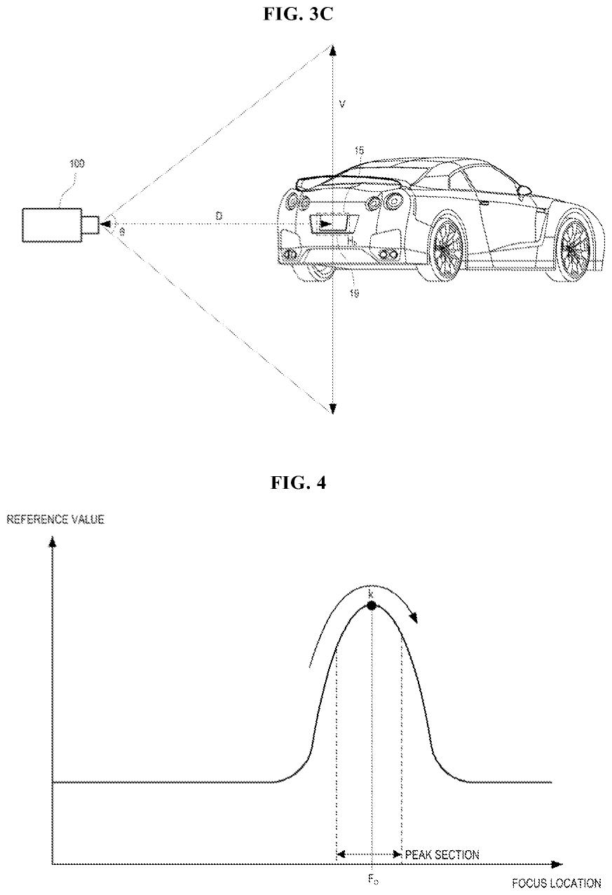

FIGS. 3A to 3C are diagrams illustrating examples of determining distances to specific objects using only images captured by the camera device 100, according to some embodiments of the present disclosure. FIG. 3A illustrates an example of determining a distance between the camera device 100 and a person based on an entire size of an object (for example, the person) included in the image.

In FIG. 3A, a value to be determined is a distance D between the camera device 100 and the object 10 (e.g., a person). An angle of view of the camera device 100 in a vertical direction is expressed as θ, and a size in the vertical direction that may be image-captured by the camera device 100 according to the angle of view θ is expressed as V. In addition, the size of the object 10 such as the person may be displayed in the form of a box 15 by the object identifier 130 described above, and the size of the object 10 in the vertical direction may be defined as H.

The angle of view θ of the camera device 100 may be obtained from specification information of the camera device 100, and the specification information may be stored in advance in the storage 170.

In this case, a ratio between the size V in the vertical direction (that may be image-captured) and the size H of the object 10 in the vertical direction (e.g., height of the person when the object 10 is the person) may be considered to be the same as a ratio of a size of the object 10 in the image to a size, in the vertical direction, of the image captured by the image sensor 110. Accordingly, when the size of the image in the vertical direction is assumed to be 100 and the ratio of the size of the object to the size of the image in the vertical direction is P (%), a relationship as represented in Equation (1) is established.

$$\frac{H}{V} = \frac{P}{100} \qquad ( 1 )$$

In addition, Equation (2) is satisfied between the distance D and the size V in the vertical direction that may be image-captured. θ refers to the angle of view of the camera device 100 in the vertical direction, and more precisely, an angle of view in the vertical direction at a specific magnification.

$$V = 2 \times D \times tan ( \frac{θ}{2} ) \qquad ( 2 )$$

Accordingly, when Equation (1) and Equation (2) are combined with each other, the distance D to be finally obtained is determined as represented in Equation (3).

$$D = \frac{50 \times H}{P \times tan ( \frac{θ}{2} )} \qquad ( 3 )$$

In Equation (3), the angle of view θ may be obtained from specifications of the camera device 100, and the ratio P of the size of the object may be obtained by confirming the image captured by the image sensor 110. For example, when the number of vertical pixels in the captured image is 1080 and the number of vertical pixels occupied by a specific object in the captured image is 216, the ratio P of the size of the object 10 will be 20.

In addition, assuming that the angle of view θ is 30°, H, which corresponds to the height of the person, may be considered to be approximately 1 m to 2 m, and thus, a minimum value of D will be 9.25 m and a maximum value of D will be 18.5 m.

Since the distance between the camera device 100 and the object 10 is reduced to a predetermined range rather than an entire distance range (0 to infinity) through simple calculation as described above, when an optimal focus location is searched and determined using the predetermined range as a reference point, a time of an autofocusing operation may decrease.

In addition, a more accurate determination may be performed by additionally reflecting a location of the object 10, lens distortion information, and the like, and in the case of a zoom camera where the angle of view changes, the distance may be rapidly determined by storing distance values for each object size in a table according to each magnification. However, such distance determination is enough to narrow a focus search range during the autofocusing operation, and may thus be sufficiently utilized even though accuracy is not perfect or optimal.

In FIG. 3A, the distance D between the camera device 100 and the object 10 may be determined based on the entire size of the object 10, such as the height of the person. However, as described above, the height of the person may have considerably various ranges and may change depending on a posture, even in the case of the same person. Therefore, in FIG. 3B, the distance D may be determined by applying Equation (3) described above based on a size Hₐ of a portion of the object, (for example, a face 17 of the person) in the vertical direction. Particularly, in the face 17 of the person, feature points of the face such as eyes, a nose, and a mouth may be clear and a deviation between sizes of the feature points may be small. Thus, a more accurate result may be obtained.

When a portion of an object having a more standardized size than the face of the person is used, accuracy of the determine of the distance D may be further increased. As illustrated in FIG. 3C, a license plate 19 of a vehicle may have a standardized size in horizontal and vertical directions according to standardized regulations. Accordingly, the distance D may be determined by applying Equation (3) described above based on a size H_{b} of the license plate 19 of the vehicle in the vertical direction. In this case, accuracy of the determined distance D may be higher than that in comparison to other types of objects as described above.

Referring again to FIG. 2, the controller 150 may drive the lens driver 120 so as to move the lens 105 in a focus range including at least a focus location of the lens 105 corresponding to the distance D determined by the distance measurement device 160. In addition, the controller 150 may search for and determine an optimal focus location where a reference value is largest in the focus range.

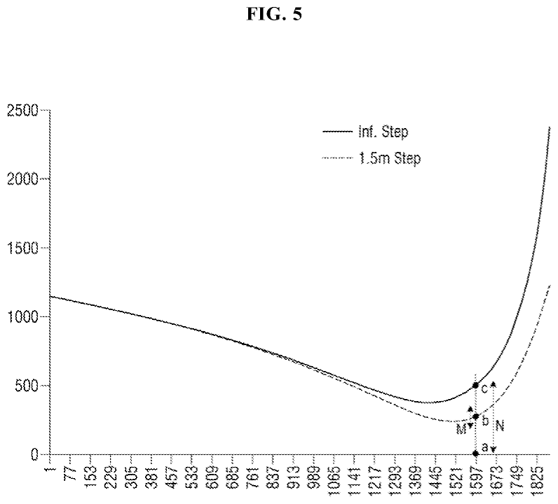

FIG. 4 is a diagram illustrating a process of determining the optimal focus location F, where the reference value is the largest as described above, according to some embodiments of the disclosure. The controller 150 may continuously check a change in the reference value while the focus location of the lens 105 moves. The controller 150 may first identify a peak section including a point where a peak value occurs (peak point) while moving the lens 105 in a relatively large step. Once the peak section is identified, the controller 150 may identify a final peak point k while finely moving the lens 105 in the peak section, and a focus location at such a peak point k is set to the optimal focus location Fₒ.

Finally, the controller 150 may drive the lens driver 120 to move the lens 105 to the optimal focus location Fₒ, such that the autofocusing operation is completed.

Contrast data or edge data may generally be used as the reference value. Such contrast data may be defined as the sum of absolute differences (SAD) between pixels in a region of interest and surrounding pixels, and the larger the SAD, the more the edge data or the more details of the image. Generally, the more accurate the focus, the higher the value of the edge data.

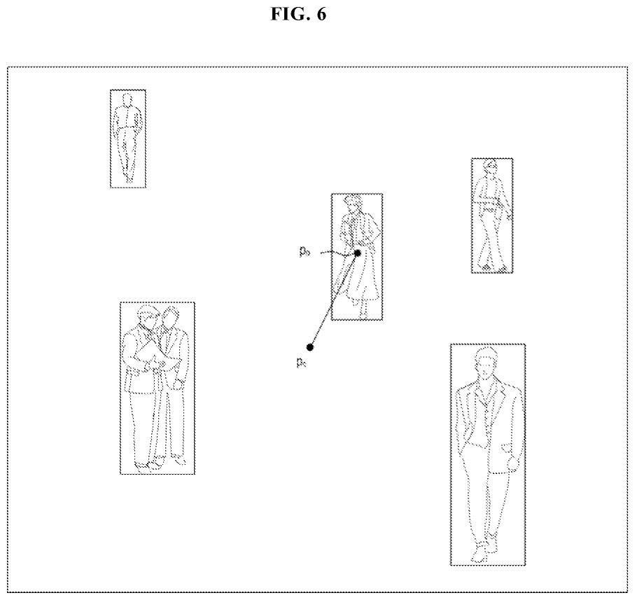

FIG. 5 is a graph of locus data illustrating a change in focus location at a specific magnification according to some embodiments of the present disclosure. As described above, the determined distance D may have a corresponding relationship with the focus location of the lens 105. Such locus data may be stored in advance in the storage 170 as specification information of the camera device 100. The horizontal axis may represent a zoom magnification of the camera device 100, and the vertical axis may represent a focus location of the camera device 100.

FIG. 5 exemplarily illustrates locus data (solid line) at an infinite Inf distance and locus data (dotted line) at a distance of 1.5 m. For example, at a location where the zoom magnification is 1597, the focus location at the distance of 1.5 m is approximately 300, and the focus location at the infinite distance is approximately 500. In the case of a general autofocusing function, the optimal focus location should be searched from a very close distance to the infinite distance (that is, in a range N of 0 to 500). On the other hand, as disclosed herein, for example, when the determined distance D is 1.5 m, the optimal focus location may only be required to be searched in a reduced margin range (that is, a focus range M, including at least the determined focus location b, and thus, a time required for the autofocusing operation decreases, such that rapid autofocusing becomes possible.

Hereinabove, a process of determining the distance D based on the object in the image and finding the optimal focus location using the determined distance D has been described. However, in many cases, there may be a plurality of objects rather than only one object in an image. Accordingly, in some embodiment, an object that is a basis for determined the distance D in the captured image may be one or some of the objects among the plurality of objects.

In some embodiment where one of the plurality of objects is selected, the selected object may be an object closest to the center of the captured image among the plurality of objects.

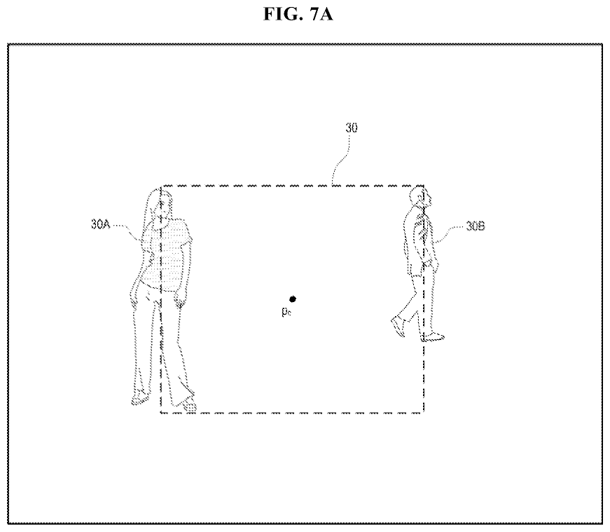

FIG. 6 is a diagram illustrating an example of determining a distance based on an object close to the center of an image among a plurality of objects according to some embodiments of the present disclosures.

When a camera performs autofocus (AF) based on the center of the image, in the case where there are no objects at the center pc of the image, objects may be out of focus through the AF, such that a blurry image may be obtained. When the camera device 100 includes the object identifier 130 as illustrated in FIG. 2, distance D may be determined based on an object pₒ selected among the plurality of objects. However, a basis for selecting an object among the plurality of objects in the image may be determined. Generally, in most cases, a user may place a target for which he/she wants to capture an image at the center of the image. Therefore, in some embodiments, the object pₒ closest to the center pc of the image among the plurality of objects is selected.

However, all of the plurality of objects are persons in FIG. 6, but persons and other types of objects may be mixed in the image. That is, when the plurality of objects in the image include different types of two or more objects, the basis for selecting the object may be differently determined. For example, in an image in which the object having the portion (e.g., the license plate) having the standardized size as illustrated in FIG. 3C and the other object are mixed, the distance D may be determined based on the object having the portion of the standardized size rather than based on the object being close to the center of the image.

In some embodiments, the distance D may be determined based on an object having a high object probability.

As described above, the object identifier 130 may identify the object using a deep learning-based object detection algorithm, and as a result, obtain an accuracy of object identification (that is, an object probability). In this case, the distance D may be determined based on the object having the highest object probability or accuracy among the plurality of objects in the image. Thus, the distance D may be prevented from being completely incorrectly determined, which may hinder a rapid autofocusing operation when the type of object is misjudged.

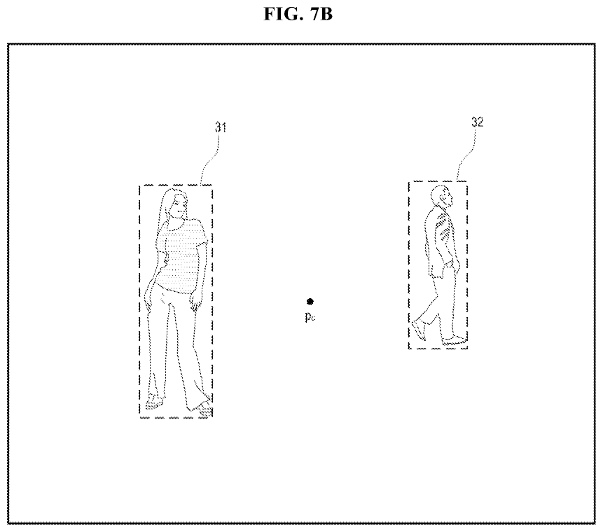

FIGS. 7A and 7B are diagrams illustrating a process of setting an AF window used when a controller 150 determines a location of a lens 11 having maximum sharpness from contrast data according to some embodiments of the present disclosure. The process of FIG. 6 may be used in a method of selecting the object as the basis for determining the distance D by the distance measurement device 160, while the process of FIGS. 7A and 7B may be used in a method of searching for and determining the optimal focus location based on the contrast data subsequently performed by the controller 150.

Generally, in order to prevent excessive computation, an optimal focus search may be performed in an AF window set in the image rather than over the entire image. That is, the controller 150 may determine the contrast data in order to search for the optimal focus location in the AF window. Accuracy of the search for the optimal focus location may change depending on how such an AF window is set. For example, when the AF window 30 is simply set at the center pc of the image as illustrated in FIG. 7A, two objects may be included in the AF window 30, such as object 30A and 30B. When edge data are more in an object of a distant location (object 30B) than in an object of a close location (object 30A), the optimal focus location may be inaccurately determined.

As described above, the object identifier 130 may identify the objects by the deep learning-based object detection algorithm and may already have information regarding size information of the objects. Thus, regions 31 and 32 occupied by respective objects may be set as respective AF windows. Alternatively, region 31 or region 32 singularly may be set as the AF window. Such object-based AF window setting may increase accuracy and rapidness of the autofocus.

Even though the controller 150 may determine the focus location based on the distance D determined by the distance measurement device 160 as described above, the controller 150 may set a focus range including the focus location with a predetermined margin and may search for and determine the optimal focus location in the focus range. However, there is a trade-off in that the larger the size of the focus range (that is, the size of the margin), the higher the accuracy but the slower the AF speed, and the smaller the size of the focus range, the faster the AF speed but the lower the accuracy.

Accordingly, in some embodiments of the present disclosure, the accuracy of the object (that is, the object probability) obtained from the object identifier 130 may be used to determine the size of the margin. As the accuracy becomes higher, the focus range may be set to be narrower (the margin is set to be smaller), and as the accuracy becomes lower, the focus range may be set to be wider (the margin is set to be larger). Such a variable margin may change depending on the object probability according to the deep learning-based object detection algorithm, and may thus be appropriately adjusted according to situations of the objects in the image.

Embodiments of setting the AF in a currently captured image have been described so far. However, in a situation where the object in the image moves at a predetermined speed or more, it may be difficult to achieve response performance corresponding to a moving speed of the object even though the autofocusing is quickly performed. Accordingly, in some embodiments of the present disclosure, a method of setting an AF window at a predicted location to be moved according to a moving speed of a moving object may be provided.

First, the controller 150 may set an AF window in the captured image and may search for and determine the optimal focus location in the set AF window. When it is identified by the object identifier 130 that movement of the identified object is a predetermined threshold value or more, the controller 150 may set the AF window in consideration of the movement of the object.

In some embodiments, the controller 150 may change and set a size of the AF window when the movement of the object results in the object becoming close to or far from the image sensor 110 (close or far movement). When the object moves close to the image sensor 110, the size of the AF window may be significantly changed in advance, and when the object moves far from the image sensor 110, the size of the AF window may be significantly changed in advance.

In addition, in some embodiments, when the movement of the object causes the object to move to another location in the captured image (two-dimensional movement), the controller 150 may move and set the AF window in advance to a predicted location according to the movement. When the movement of the object is a combination of close or far movement and two-dimensional movement, the controller 150 may change a size and a location of the AF window in consideration of both the close or far movement and the two-dimensional movement.

FIG. 8A is a block diagram illustrating an AI device according to some embodiments of the present disclosure. FIG. 8B is a diagram illustrating an example of a deep neural network (DNN) model according to some embodiments of the present disclosure.

An AI device 20 may include a communication device 27 including an AI module capable of performing AI processing, a server 28 including the AI module, or the like. In addition, the AI device 20 may be included as at least a part in a communication device 27 and may be provided to perform at least some of AI processing together. The AI device 20 may include an AI processor 21, a memory 25 and/or a communication device 27.

The AI device 20 may be a computing device capable of learning a neural network, and may be implemented as various electronic devices such as a server, a desktop personal computer PC, a notebook PC, and a tablet PC.

The AI processor 21 may learn a neural network by using a program stored in the memory 25. In particular, the AI processor 21 may learn a neural network for recognizing object-related data. The neural network for recognizing object-related data may be designed to simulate a human brain structure on a computer, and may include a plurality of network nodes with weights that simulate neurons of the human neural network. The plurality of network modes may exchange data according to their respective connection relationships such that neurons may simulate the synaptic activity of neurons for sending and receiving signals through synapses. The neural network may include a deep learning model developed from a neural network model. In the deep learning model, a plurality of network nodes may be located in different layers and exchange data according to a convolutional connection relationship. Examples of neural network models include various deep learning techniques, such as DNNs, convolutional neural networks (CNNs), recurrent neural networks (RNNs), restricted Boltzmann machine (RBMs), deep belief networks (DBNs), or Deep Q-Networks, and may be applied to fields such as computer vision, speech recognition, natural language processing, and speech/signal processing.

The processor that performs the functions as described above may be a general-purpose processor (e.g., CPU), but may be an AI dedicated processor (e.g., graphical processing unit (GPU)) for artificial intelligence learning. The memory 25 may store various programs and data required for the operation of the AI device 20. The memory 25 may be implemented by a non-volatile memory, a volatile memory, a flash memory, a hard disk drive (HDD), a solid state drive (SDD), or the like. The memory 25 is accessed by the AI processor 21, and data read/write/edit/delete/update by the AI processor 21 may be performed. In addition, the memory 25 may store a neural network model (e.g., a deep learning model 26) generated through a learning algorithm for data classification/recognition in accordance with some embodiments of the present disclosure.

The AI processor 21 may include a data learning processor 22, a training data acquisition processor 23, and a model learning processor 24, which may be processors, subprocessors, modules, units, etc., as will be understood by one of ordinary skill in the art from the disclosure herein.

The AI processor 21 may include a data learning processor 22 for learning a neural network for data classification/recognition. The data learning processor 22 may learn a criterion on which training data to use and how to classify and recognize data using the training data in order to determine data classification/recognition. The data learning processor 22 may learn the deep learning model by acquiring training data to be used for learning and applying the acquired training data to the deep learning model.

The data learning processor 22 may be manufactured in the form of at least one hardware chip and mounted on the AI device 20. For example, the data learning processor 22 may be manufactured in the form of a dedicated hardware chip for AI, or may be manufactured as a portion of a general-purpose processor (CPU) or a dedicated graphics processor (GPU) and mounted on the AI device 20. In addition, the data learning processor 22 may be implemented as a software module. When implemented as a software module (or a program module including an instruction), the software module may be stored in a non-transitory computer-readable medium. In this case, at least one software module may be provided by an operating system (OS) or an application.

The data learning processor 22 may include a training data acquisition processor 23 and a model learning processor 24.

The training data acquisition processor 23 may acquire training data requested for the neural network model for classifying and recognizing data. For example, the training data acquisition processor 23 may acquire object data and/or sample data for input into the neural network model as training data.

The model learning processor 24 may be trained to have a criterion for determining how the neural network model classifies predetermined data by using the acquired training data. In this case, the model learning processor 24 may train the neural network model through supervised learning using at least a portion of the training data as a criterion for determination. Alternatively, the model learning processor 24 may train the neural network model through unsupervised learning to discover a criterion by self-learning using the training data without being supervised. In addition, the model learning processor 24 may train the neural network model through reinforcement learning by using feedback on whether the result of situation determination based on the learning being correct. In addition, the model learning processor 24 may train the neural network model by using a learning algorithm including an error back-propagation method or a gradient decent method.

When the neural network model is trained, the model learning processor 24 may store the learned neural network model in the memory. The model learning processor 24 may store the learned neural network model in a memory of a server connected to the AI device 20 via a wired or wireless network.

The data learning processor 22 may further include a training data preprocessor and a training data selection unit in order to improve the analysis result of the recognition model or to save resources or time required for generating the recognition model.

The training data preprocessor may preprocess the acquired data such that the acquired data may be used for learning to determine the situation. For example, the training data preprocessor may process the acquired data into a preset format such that the model learning processor 24 may use the training data acquired for learning for image recognition.

In addition, the training data selection unit may select data required for training from the training data acquired by the training data acquisition processor 23 or the training data preprocessed by the preprocessor. The selected training data may be provided to the model learning processor 24. For example, the training data selection unit may select only data on an object included in a specific region as the training data by detecting the specific region among images acquired through a camera device.

In addition, the data learning processor 22 may further include a model evaluation processor to improve the analysis result of the neural network model.

The model evaluation processor may input evaluation data to the neural network model, and may cause the model learning processor 24 to retrain the neural network model when an analysis result output from the evaluation data does not satisfy a predetermined criterion. In this case, the evaluation data may be predefined data for evaluating the recognition model. For example, the model evaluation processor may evaluate the model as not satisfying a predetermined criterion when, among the analysis results of the trained recognition model for the evaluation data, the number or ratio of evaluation data for which the analysis result is inaccurate exceeds a preset threshold. The communication device 27 may transmit the AI processing result by the AI processor 21 to an external communication device.

Referring to FIG. 8B, the DNN may be an artificial neural network including several hidden layers (e.g., hidden layer 1 and hidden layer 2) between an input layer and an output layer. The DNN may model complex non-linear relationships.

For example, in a DNN structure for an object identification model, each object may be represented as a hierarchical configuration of basic image elements. In this case, the additional layers may aggregate the characteristics of the gradually gathered lower layers. This feature of DNNs allows more complex data to be modeled with fewer units (nodes) than similarly performed artificial neural networks.

As the number of hidden layers increases, the artificial neural network is called ‘deep’, and a machine learning paradigm that uses such a sufficiently deepened artificial neural network as a learning model is called deep learning. Furthermore, the sufficiently deep artificial neural network used for the deep learning is commonly referred to as the DNN.

In some embodiments, data required to train an object data generation model may be input to the input layer of the DNN, and meaningful evaluation data that may be used by a user may be generated through the output layer while the data pass through the hidden layers. In this way, the accuracy of the evaluation data trained through the neural network model can be represented by a probability, and the higher the probability, the higher the accuracy of the evaluated result.

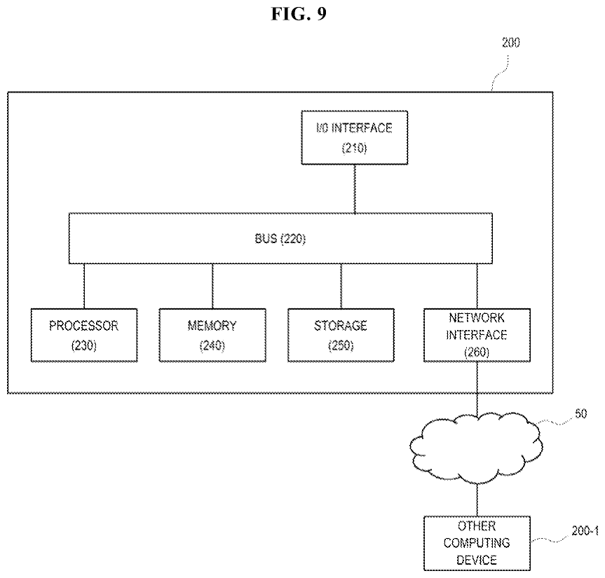

FIG. 9 is a block diagram illustrating the hardware configuration of a computing device 200 that implements a camera device 100 according to some embodiments of the present disclosure.

Referring to FIG. 9, a computing device 200 may include a bus 220, a processor 230, a memory 240, a storage 250, an input/output (I/O) interface 210, and a network interface 260. The bus 220 may be a path for the transmission of data between the processor 230, the memory 240, the storage 250, the I/O interface 210, and the network interface 260. However, embodiments are not particularly limited how the processor 230, the memory 240, the storage 250, the I/O interface 210, and the network interface 260 are connected. The processor 230 may be an arithmetic processor such as a (CPU or a GPU. The memory 240 may be a memory such as a random-access memory (RAM) or a read-only memory (ROM). The storage 250 may be a storage device such as a hard disk, a solid state drive (SSD), or a memory card. The storage 250 may also be a memory such as a RAM or a ROM.

The I/O interface 210 may be an interface for connecting the computing device 200 and an I/O device. For example, a keyboard or a mouse is connected to the I/O interface 210.

The network interface 260 may be an interface for communicatively connecting the computing device 200 and an external device to exchange transport packets with each other. The network interface 260 may be a network interface for connection to a wired line or for connection to a wireless line. For example, the computing device 200 may be connected to another computing device 200-1 via a network 50.

The storage 250 may store program modules that implement the functions of the computing device 200. The processor 230 may implement the functions of the computing device 200 by executing the program modules. The processor 230 may read the program modules into the memory 240 and may then execute the program modules.

The hardware configuration of the computing device 200 is not particularly limited to the construction illustrated in FIG. 9. For example, the program modules may be stored in the memory 240. In this example, the computing device 200 may not include the storage 250.

The camera device 100 may at least include the processor 230 and the memory 240, which stores instructions that may be executed by the processor 230. For example, the camera device 100 of FIG. 2 may be driven by executing instructions including a variety of functional blocks or steps included in the camera device 100, via the processor 230.

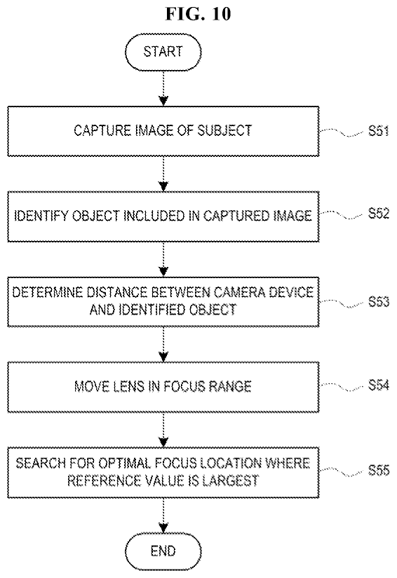

FIG. 10 is a flowchart illustrating an AF adjustment method in the camera device 100 according to some embodiments of the present disclosure.

In operation S51, the image sensor 110 may capture an image of the subject.

In operation S52, the object identifier 130 may identify an object included in the captured image using the deep learning-based object detection algorithm.

In operation S53, the distance measurement device 160 may determine a distance between the camera device 100 and the identified object based on an occupancy percentage of the identified object in the captured image.

In operation S54, the controller 150 may move the lens 105 in a focus range including at least a focus location of the lens corresponding to the determined distance.

In operation S55, the controller 150 may search for and determine an optimal focus location at which a reference value is the largest while the lens 105 is moving.

In operation S53, more specifically, the distance measurement device 160 may acquire an angle of view in the vertical direction based on specification information of the camera device 100, and may determine the distance between the camera device 100 and the identified object using the acquired angle of view in the vertical direction, a ratio of a size of the object, and a physical size of the object. In this case, the ratio of the size of the object may be a ratio of a size of the entirety or a portion of the object in the vertical direction to a size of the captured image in the vertical direction.

The object may be an object selected among a plurality of objects included in the captured image, and the selected object may be an object closest to the center of the captured image among the plurality of objects.

Alternatively, the object may be an object selected among a plurality of objects included in the captured image. The plurality of objects may include different types of two or more objects, and the selected object may be an object whose size of the entirety or a portion is standardized among the two or more objects.

Alternatively, the identification of the object may be performed by the deep learning-based object detection algorithm, accuracy for the identification of the object may be obtained as a result of the identification, and an object having higher accuracy among the plurality of objects included in the captured image may be selected as the identified object.

According to some embodiments of the present disclosure, performance deterioration due to inaccuracy of focus may be decreased while also decreasing a time required for AF by narrowing an AF search range in contrast AF technology.

In addition, according to some embodiments of the present disclosure, convenience of a user may be improved by providing a graphic user interface (GUI) so that the user may select a search range in a setting of a camera.

Further, more rapid and accurate autofocusing may be achieved according to embodiments of the disclosure by adding a distance measuring device such as a laser.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to some embodiments, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to some embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least portion of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments including, but not limited to, FIGS. 2, 8A, 8B and 9 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A camera device, comprising:
an image sensor configured to capture an image;
an object identifier configured to identify an object included in the captured image;
a distance measurement device configured to determine a distance between the camera device and the identified object based on an occupancy percentage of the identified object in the captured image; and
a controller configured to determine an optimal focus location where a reference value is the largest while moving a lens in a focus range corresponding to the determined distance between the camera device and the identified object, the focus range including at least a focus location of the lens.

2. The camera device of claim 1, wherein the reference value comprises contrast data or edge data.

3. The camera device of claim 1, further comprising a storage configured to store specification information of the camera device,
wherein the distance measurement device is further configured to obtain an angle of view in a vertical direction from the specification information;
wherein the distance measurement device is configured to determine the distance between the camera device and the identified object based on the obtained angle of view in the vertical direction, a ratio of a size of the identified object, and a physical size of the identified object, and
wherein the ratio of the size of the identified object corresponds a ratio of a size of at least a portion of the identified object in the vertical direction to a size of the captured image in the vertical direction.

4. The camera device of claim 3, wherein the object comprises a person, and
wherein the portion of the object comprises a face of the person.

5. The camera device of claim 3, wherein the object comprises a vehicle, and
wherein the portion of the object comprises a license plate of the vehicle.

6. The camera device of claim 3, wherein the controller is further configured to:
obtain locus data from the specification information stored in the storage; and
determine the focus range based on the determined distance between the camera device and the identified object and based on the locus data, and
wherein the locus data corresponds to a focus location determined based on a distance to the object at a specific zoom magnification.

7. The camera device of claim 1, wherein the captured image comprises a plurality of objects, and
wherein the identified object is an object selected among the plurality of objects.

8. The camera device of claim 7, wherein the identified object is selected as an object closest to a center of the captured image among the plurality of objects.

9. The camera device of claim 7, wherein the identified object is selected as an object comprising a size that is standardized among the plurality of objects.

10. The camera device of claim 7, wherein the object identifier is configured to identify the object based on a deep learning-based object detection algorithm,
wherein the object identifier is configured to obtain an accuracy of the plurality of objects based on the deep learning-based object detection algorithm, and
wherein the identified object is selected as an object having higher accuracy among the plurality of objects.

11. The camera device of claim 7, wherein the controller is further configured to set a window in the captured image around the identified object, and
wherein the controller is configured to determine the optimal focus location in the set window.

12. The camera device of claim 1, wherein the object identifier is configured to identify the object based on a deep learning-based object detection algorithm,
wherein the object identifier is configured to obtain an accuracy of the identified object based on the deep learning-based object detection algorithm, and
wherein the focus range is set based on the obtained accuracy.

13. The camera device of claim 1, wherein the controller is further configured to set a window in the captured image based on a movement of the identified object, and
wherein the controller is configured to determine the optimal focus location in the set window.

14. The camera device of claim 13, wherein the controller is further configured to change a size of the window based on the movement of the identified object with respect to the image sensor.

15. The camera device of claim 13, wherein the controller is further configured to moves and set the window to a predicted location based on movement of the identified object to another location in the captured image.

16. An autofocus adjustment method performed by a camera device, the autofocus adjustment method comprising:
capturing an image;
identifying an object included in the captured image;
determining a distance between the camera device and the identified object based on an occupancy percentage of the identified object in the captured image;
moving a lens in a focus range of the lens based on the determined distance between the camera device and the identified object, the focus range including at least a focus location of the lens; and
determining an optimal focus location where a reference value is the largest while moving the lens.

17. The autofocus adjustment method of claim 16, further comprising:
obtaining an angle of view in a vertical direction based on specification information of the camera device;
wherein determining the distance between the camera device and the identified object is performed based on the obtained angle of view in the vertical direction, a ratio of a size of the object, and a physical size of the object, and
wherein the ratio of the size of the identified object corresponds a ratio of a size of at least a portion of the identified object in the vertical direction to a size of the captured image in the vertical direction.

18. The autofocus adjustment method of claim 16, wherein the captured image comprises a plurality of objects,
wherein the identified object is an object selected among the plurality of objects, and
wherein the identified object is selected as an object closest to a center of the captured image among the plurality of objects.

19. The autofocus adjustment method of claim 16, wherein the captured image comprises a plurality of objects,
wherein the identified object is an object selected among the plurality of objects, and
wherein the identified object is selected an object comprising a size that is standardized among the plurality of objects.

20. The autofocus adjustment method of claim 16, wherein the identifying of the object is performed based on a deep learning-based object detection algorithm,
wherein the identifying the object comprises:
obtaining an accuracy of the identification of the object, and
identifying the object as an object having higher accuracy among a plurality of objects included in the captured image.

21. A non-transitory computer-readable storage medium storing instructions that, when executed by at least one processor, cause the at least one processor to:
capture an image;
identify an object included in the captured image;
determine a distance between a camera device and the identified object based on an occupancy percentage of the identified object in the captured image;
move a lens in a focus range of the lens based on the determined distance between the camera device and the identified object, the focus range including at least a focus location of the lens; and
determine an optimal focus location where a reference value is the largest while moving the lens.
